(19) United States
(12) Patent Application Publication
(10) Pub. No.: US 2003/0131524 A1
(43) Pub. Date: Jul. 17, 2003

(54) Hand held device to capture and dispose of crawling insects

(76) Inventor: Jo-Anne Hodges Brown, Carson City, NV (US)

Correspondence Address: Joseph H. McGlynn, 6111 Saddle Horn DR., Fairfax, VA, 22030, US

(21) Appl. No.: 10/045,424

(22) Filed: Jan. 12, 2002

(51) Int. Cl. A01M 5/02; A01M 3/00

(52) U.S. Cl. 43/134

(57) ABSTRACT

A hand-held trap for crawling insects is provided to capture insects alive from walls and floors, and allow for their subsequent disposal. The apparatus includes an enclosure comprising a horizontal baseplate with a spring-loaded hinged lid attached to a rigid handle. The handle is angled in the vertical plane to the horizontal. The leading edge of the baseplate is beveled so that it will readily slide under an insect. The enclosure is opened by moving rearwardly a manual control element which is situated toward the end of the handle. Opening the lid compresses the spring in the hinge. Upon releasing the manual control element, the enclosure lid is urged, by the spring hinge to return to the closed position. Both the baseplate and the enclosure lid have a plurality of holes which will allow the passage of air and water, but which are too small to allow a captured insect to escape.

### FEDERALLY SPONSORED RESEARCH

Not applicable

### SEQUENCE LISTING OR PROGRAM

Not applicable

### BACKGROUND

1. Field of Invention

This invention relates to the capture and subsequent release of household insects.

2. DESCRIPTION OF PRIOR ART

Spiders, cockroaches, earwigs, sow bugs, and other varieties of crawling insects have always been pests within a household.

Originally, householders' only recourse to rid themselves of such pests was to scoop them up, pick them up or crush them on the floor or walls. These unpleasant methods often left stains on the walls or floors and exposed people to the possibility of bites and stings.

Many systems and devices for destroying such pests have been devised. These range from wholesale liquidation by means of fumigation with poison gas, or spraying insecticide inside the dwelling, to traps coated with adhesives. Some traps required the addition of bait.

Thereafter, inventors created several types of device to capture and dispose of crawling insects within the house. U.S. Pat. No. 5,207,018 to Reaver, et al (1993) discloses an insect trap which is said to be capable of capturing an insect alive. Since the handle of the device is resiliently flexible in order for it to perform its role as a fly swatter, it would have to be kept flat for the slide mechanism to operate thus requiring the user to stoop very low, or to kneel on the floor to operate it. Similarly, it is very awkward to use on a wall as the device has to be held flat against the wall in order to operate the slide. Since the baseplate is raised off the floor slightly, it appears that an insect would be crushed when the planar mesh enclosure is extended from its rearward position to the forward position.

U.S. patent application 20010001353 of Jones, Robert for a trap for insects and small rodents is a static device which will only be effective for use on the floor. This trap also requires the use of adhesives and bait. The device precludes release of insects, unharmed, outside the house.

### OBJECTS AND ADVANTAGES

Accordingly, besides the objects and advantages of the insect trap described in my above patent, several objects and advantages of the present invention are:

(a) to provide an insect trap which is practical;

(b) to provide an insect trap which is simple to use;

(c) to provide an insect trap which is safe, and is not harmful to children or pets;

(d) to provide an insect trap which does not use adhesives, poisons, or bait;

(e) to provide an insect trap which does not require the user to assume awkward postures;

(f) to provide an insect trap which will capture an insect high on a wall;

(g) to provide an insect trap which offers the option of releasing the captured insect unharmed, or to destroy it outside the house by drowning or other means;

Further objects and advantages of my invention will become apparent from a consideration of the drawings and ensuing description.

### SUMMARY

In accordance with present invention an insect trap comprises a planar baseplate, a walled insect enclosure and a spring-hinged enclosure lid which is opened by a pull-belt connected to said lid and a slidable manual control element. The enclosure is connected to a handle. The manual control element is mounted toward the rear of the handle.

### DRAWINGS

Drawing Figures

FIG. 1 is a top, front and right side perspective view of an insect trap embodying the invention, wherein the enclosure lid is illustrated in its closed position.

FIG. 2 is a side view of the right side of the invention, wherein the enclosure lid is illustrated in its open position.

FIG. 3 is an enlarged vertical section taken generally along the line 3--3 of FIG. 1, illustrating the manner in which the manual control element fits into the guide slots at the rear of the handle.

FIG. 4 is an enlarged perspective view of the top, front and right side of the manual control element.

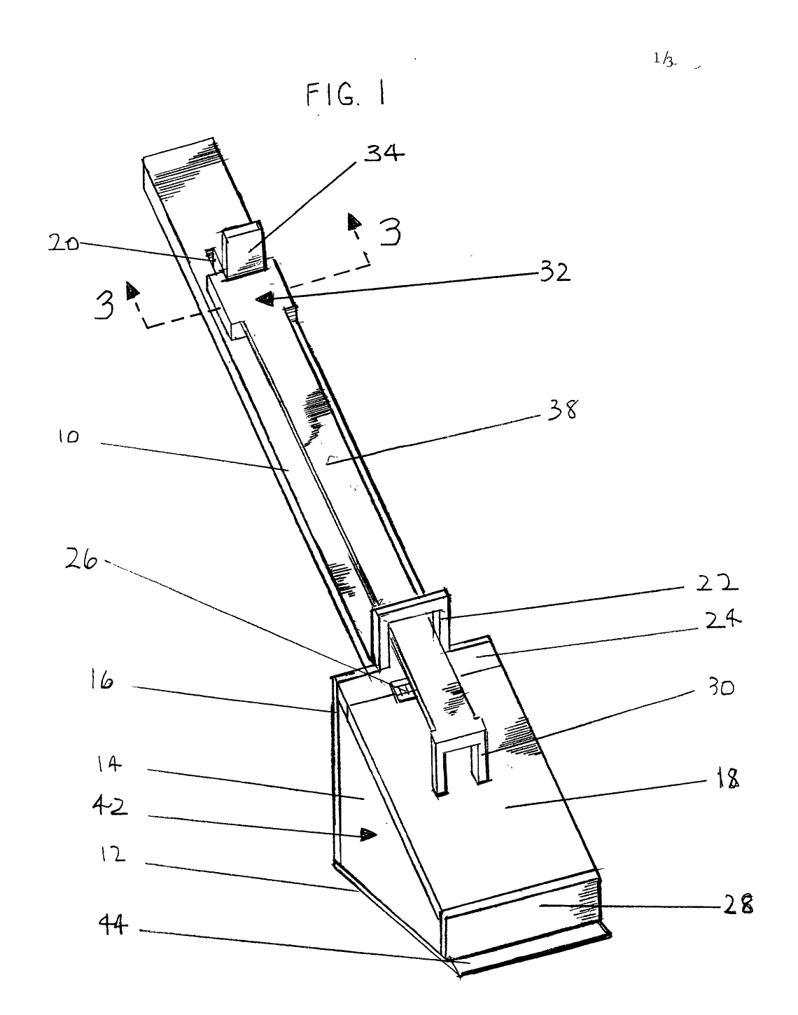

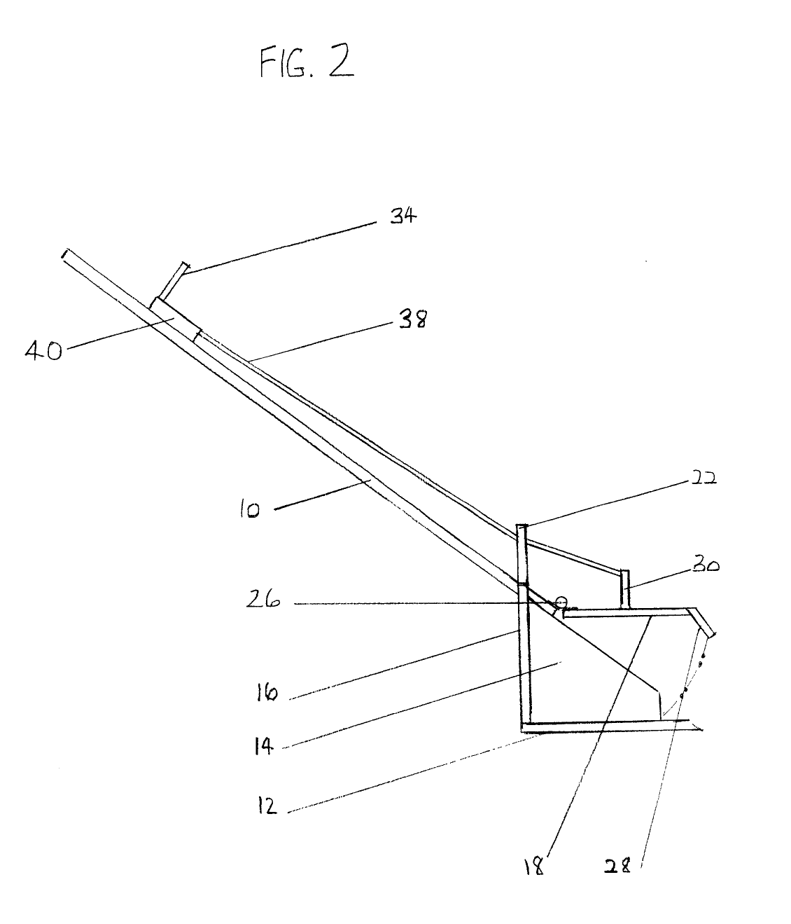

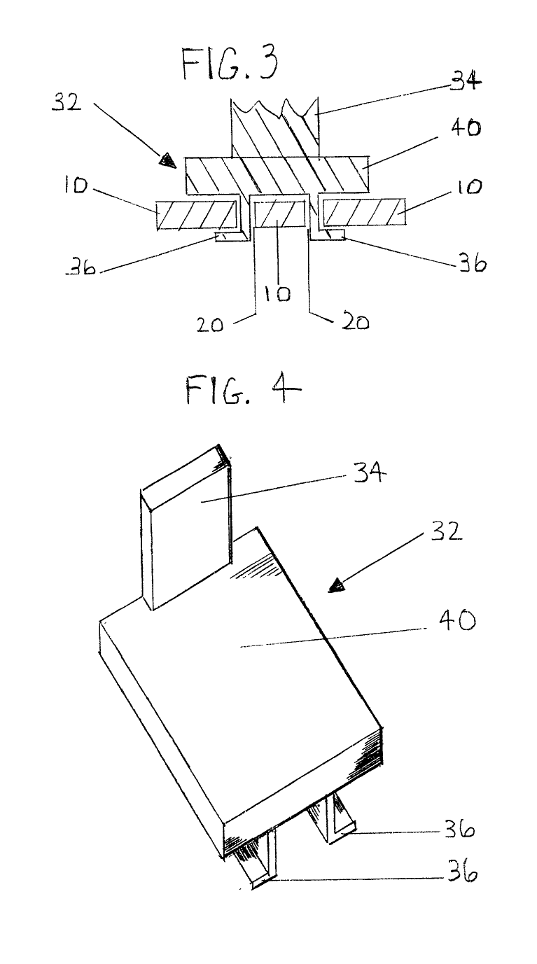

Reference Numerals in Figures

10 handle

12 baseplate

14 side wall

16 rear wall

18 lid

20 guide slot

22 rear wall projection

24 fillet

26 spring hinge

28 lid flange

30 lid projection

32 manual control element

34 trigger

36 flanged rail

38 belt

40 platform

42 insect enclosure

44 beveled leading edge

### DETAILED DESCRIPTION OF THE PREFERRED EMBODIMENT

As shown in the drawings for purposes of illustration, the present invention is concerned with an insect trap that is capable of capturing crawling insects alive from given surfaces to allow for their subsequent disposal.

In accordance with the present invention, the trap comprises an elongate rigid handle 10 which has a generally rectangular cross-sectional configuration. Handle 10 has a rear end intended to be grasped by the user and a front end which is attached to rear wall 16 of insect enclosure 42. Handle 10 has two parallel guide slots 20 situated toward the rear end of handle 10.

Insect enclosure 42 is formed of a rigid material, having a planar baseplate 12, two side walls 14, a rear wall 16, and an enclosure lid 18. The planar baseplate 12 is beveled at the front edge 44 and protrudes beyond the front edges of the side walls 14. The rear wall 16 has a vertical square projection 22 located centrally.

The two side walls 14 are quadrilateral in shape and arranged such that the front edges are of lesser dimension than the rear edges. Side walls 14, rear wall 16, baseplate 12, and lid 18 include a plurality of small apertures which allow air and water to pass, but which are not large enough to permit a roach-sized insect to escape through.

A fillet 24 of rectangular cross-section is attached to the rear wall 16 and the upper edges of the side walls 14.

The lid 18 is connected to the fillet 24 by a spring hinge 26. The lid 18 is configured to overlap the upper edges of the side walls 14 and to overlap the front edges of the side walls 14 by means of an attached vertical flange 28. The flange 28 makes contact with the upper surface of the baseplate 12, when the enclosure lid is in the closed position A transverse rectangular projection 30 is attached to the geometric center of the upper surface of the enclosure lid 18.

A manual control element 32 comprising a platform 40, a trigger 34 attached to the upper surface of the platform 40 at the rearward end, and two vertical rails 36 attached to the lower surface of said platform 40 and flanged outwardly, is inserted into the two guide slots 20.

A belt 38 of resiliently flexible material connects the leading edge of the manual control element 32 to the enclosure lid projection 30. The belt passes through the rear wall projection 22.

In use, the trap is opened by grasping the rear end of handle 10 and sliding trigger 34 rearward. Beveled edge 44 of planar baseplate 12 is then slid under an insect, and trigger 34 released. The captured insect may then be taken outside and disposed of.

I claim:

1. A hand-held insect trap capable of capturing crawling insects alive from given surfaces to allow their subsequent disposal, the apparatus comprising:
an elongate handle having a rear end intended to be grasped by the user, and a front end;
a rigid housing attached to the front end of the handle comprising a planar baseplate with vertical side walls and an interconnected vertical rear wall and a lid defining an insect trap enclosure; and
means for opening the lid.

2. An apparatus as set forth in claim 1, wherein said insect trap enclosure includes a plurality of small apertures which allow air and water to pass, but which are not large enough to permit a roach-sized insect to escape therethrough.

3. An apparatus as set forth in claim 1, wherein said handle has a generally flat rectangular cross-sectional configuration and is constructed of a rigid material.

4. An apparatus as set forth in claim 1, wherein towards the rear end of said handle are arranged two longitudinal, parallel slots which define the guides for a manual control element.

5. An apparatus as set forth in claim 1, wherein said planar baseplate is constructed of rigid material, and the front edge is beveled and protrudes beyond the front edges of said side walls.

6. An apparatus as set forth in claim 1, wherein said rear wall has a vertical, square projection on the center of the upper edge, said projection having a square aperture located centrally.

7. An apparatus as set forth in claim 1, wherein said two side walls are quadrilateral in shape and disposed such that the front edges of said walls are of lesser dimension than the rear edges.

8. An apparatus as set forth in claim 1, wherein a fillet of rectangular cross section is attached to said rear wall and the upper edges of said side walls.

9. An apparatus as set forth in claim 6, wherein said lid is connected to said fillet by a spring hinge.

10. An apparatus as set forth in claim 1, wherein said lid is configured to overlap the top edges of said side walls, and to overlap the front edges of said side walls by means of an attached vertical flange.

11. An apparatus as set forth in claim 8, wherein the lower edge of said flange makes contact with the upper surface of said baseplate, when said lid is in the closed position.

12. An apparatus as set forth in claim 1, wherein a transverse rectangular projection is attached to the geometric center of the upper surface of said lid.

13. An apparatus as set forth in claim 2, wherein a manual control element comprising a platform, a trigger attached to the upper surface of the platform at the rearward end, and two vertical rails attached to the lower surface of said platform and flanged outwardly, is inserted into said guide slots.

14. An apparatus as set forth in claim 1, wherein a belt of resiliently flexible material connects the leading edge of said manual control element to the said lid projection.

15. An apparatus as set forth in claim 1, wherein said belt passes through said rectangular aperture in said projection on said rear wall.
